(19) United States
(12) Patent Application Publication
(10) Pub. No.: US 2014/0278137 A1
(43) Pub. Date: Sep. 18, 2014

(54) DISTANCE MAPS USING MULTIPLE ALIGNMENT CONSENSUS CONSTRUCTION

(71) Applicant: NABSYS, INC., Providence, RI (US)

(72) Inventors: Peter Goldstein, Cambridge, MA (US); William Heaton, Cambridge, MA (US); Franco Preparata, Providence, RI (US); Eli Upfal, Providence, RI (US)

(73) Assignee: NABSYS, INC., Providence, RI (US)

(21) Appl. No.: 14/212,458

(22) Filed: Mar. 14, 2014

Related U.S. Application Data
(60) Provisional application No. 61/800,809, filed on Mar. 15, 2013.

(51) Int. Cl. G06F 19/22

(52) U.S. Cl. CPC G06F 19/22
USPC 702/19

(57) ABSTRACT

Techniques for assembly of genetic maps including de novo assembly of distance maps using multiple alignment consensus construction. Multiple map alignment can be performed on a defined bundle of fragment maps corresponding to biomolecule fragments to determine consensus events and corresponding locations. Fragment maps in the bundle can be removed when there is no overhang from the consensus events. When the subset of fragment maps in the bundle is less than a predetermined threshold, one or more additional fragment maps can be added based on fragment signatures, a consensus alignment score, and a pairwise alignment score. Techniques for multiple alignment can include generating a graph with edges and vertices representing each pairwise relation. An ordered set of sets of events best representing a multiple alignment reflecting all pairwise alignments can be generated by repeatedly randomly removing edges and combining vertices to identify a min cut of the graph.

### CROSS REFERENCE TO RELATED APPLICATION

This application claims priority to U.S. Application No. 61/800,809, entitled “Distance Maps Using Multiple Alignment Consensus Construction” filed on Mar. 15, 2013, the contents of which is hereby incorporated by reference in its entirety.

### FIELD

The presently disclosed subject matter relates to methods and systems for assembly of genetic maps. More particularly, the presently disclosed subject matter relates to techniques for de novo assembly of distance maps using multiple alignment consensus construction.

### BACKGROUND

Genetic mapping (i.e., the determination of a set of ordered distances between events on a biopolymer, including but not limited to DNA), can be thought of as a relatively low resolution measurement of a biopolymer sequence where the highest possible resolution would be the entire biopolymer sequence. Owing to repeat regions in the genome longer than the read lengths that certain high throughput sequencing technologies can attain, certain sequencing technologies can fail to capture long range information; rather, the final sequence data is typically segmented into small contiguous sequences. These longer repeat regions can create ambiguities in how to assemble the reads and therefore can create discontinuities in the resulting assembly. Genetic mapping can involve the use of reads longer than the longest repeated sequence in the genome, and thus avoid this shortcoming. Accordingly, genetic maps can be useful as supplementary data as a source of orthogonal information, which can be combined with sequencing data for a more complete and correct measurement of the genome. Moreover, full sequence data can be obtained via many mapping experiments with a library of sequence specific probes and combining that data into single base resolution sequence data.

A number of techniques for generating genetic maps are known in the art. Initially, biologists measured linkage disequilibrium between different phenotypic or genotypic variants by breeding many individuals of a species and determined a physical distance between sites based on the level of recombination between those sites as measured by the resulting phenotypes. Another technique for generating distance maps, referred to as ordered restriction digestion, can involve algorithmic construction from multiple co-restriction digestions along with measurement of the size of the resultant fragments via gel electrophoresis. Alternatively, distance maps can be acquired via direct optical detection of a biomolecule fixed on a surface, labeled with fluorophores, and restriction digested enzymatically. More recently, positional sequencing techniques have been used in connection with the generation of distance maps.

Current technologies cannot isolate and measure DNA molecules having a length on the order of an entire chromosome. To assemble chromosome or genome-scale maps, the “shotgun” method can be used. This method generally entails randomly fragmenting several copies of the genome or long scale biopolymer and making measurements of these fragments. Multiple copies and the random nature of fragmentation yield overlapping fragments (i.e., overlapping measurements of the same locus in the genome). A contiguous multi-measurement can be grown by combining measurements that overlap on one region of the genome and also extend in either direction. This process can be repeated until each chromosome is contained in a single contiguous multi-measurement. However, with current sequencing technologies, long range information is not available. If repeats longer than the measurement length exist in the genome of interest, ambiguities arise and the resulting assembly will be fragmented. Genetic maps are generally longer than any repeat in known genomes and thus do not suffer from this problem.

However, the process of comparing measurements over long length scales can be complex, costly, and time consuming. Moreover, measurement noise can exacerbate this complexity. Thus, genetic map assembly, particularly for large mammalian genomes, can require a reference genome (if available), expensive computer hardware, and/or significant processing time.

Accordingly, there is a continued need for improved techniques for comparing measurements and de novo assembly of distance maps.

### SUMMARY

The purpose and advantages of the disclosed subject matter will be set forth in and apparent from the description that follows, as well as from the appended drawings. The disclosed subject matter includes enhanced techniques for multiple alignment in the presence of positional measurement errors and techniques for de novo distance map assembly using multiple alignment consensus construction.

In one aspect of the disclosed subject matter, techniques for de novo genetic map assembly of a biomolecule include generating biomolecule fragments. One or more probes can be bound to each fragment corresponding to sequence specific binding sites. A plurality of fragment maps corresponding to the fragments can be generated by position sequencing the probes, such that each fragment map includes events and locations corresponding to the probes. Multiple map alignment can be performed on a defined bundle of fragments to determine consensus events and corresponding locations. The defined bundle can include a subset of the fragment maps, and one of the fragment maps in the bundle can be removed when there is no overhang from the consensus events. When the subset of fragment maps in the bundle is less than a predetermined threshold, one or more additional fragment maps with a particular signature can be aligned with the consensus events to generate a consensus alignment score. The additional fragment maps can then be aligned to each of the fragment maps in the bundle to generate a pairwise alignment score. If the consensus alignment score and the pairwise alignment scores exceed a significance threshold, the additional fragment maps can be added to the bundle.

In an exemplary embodiment, techniques for de novo genetic map assembly can include receiving data representative of the fragment maps at a processor. The processor can also be configured to perform a multiple map alignment on the defined bundle to determine the consensus events and corresponding locations. The processor can be configured to monitor the overhang state of each fragment map in the bundle relative to the consensus events and configured to monitor the number of fragments in the defined bundle. The processor can be configured to remove a fragment map from the bundle when the corresponding overhang state reaches one or more predetermined criteria. When the bundle size state is below a predetermined threshold, the processor can be configured to generate the consensus alignment score and pairwise alignment score for the additional fragments. In certain embodiments, a non-transitory computer readable medium can contain computer-executable instructions, which when executed cause one or more computer devices to perform the techniques disclosed herein.

In another aspect of the disclosed subject matter, a method for performing multiple alignment of fragment maps includes performing pairwise alignments between each of the fragment maps to generate a graph. The graph can have a plurality of edges and vertices representing each pairwise relation, such that each vertex of the graph corresponds to an event on one of the maps, and each edge of the graph corresponds to predicted homologous events. An ordered set of sets of events representing a multiple alignment reflecting all pairwise alignments can be generated by randomly selecting an edge, removing the selected edge and combining its vertices while retaining all other edges if the vertices of the selected edge correspond to different fragment maps. These steps can be repeated until either only two vertices remain or no further edges can be removed. In an exemplary embodiment, a plurality of ordered sets of sets of events representing a multiple alignment reflecting all pairwise alignments can be generated. The ordered set of sets of events best reflecting all pairwise alignments can be identified with high probability by selecting one of the resulting ordered sets with the fewest remaining edges.

### BRIEF DESCRIPTION OF THE DRAWINGS

The accompanying drawings, which are incorporated in and constitute part of this specification, are included to illustrate and provide a further understanding of the disclosed subject matter. Together with the description, the drawings serve to explain the principles of the disclosed subject matter.

FIG. 1A depicts pairwise alignment of events along two overlapping fragments of a biopolymer in accordance with the disclosed subject matter.

FIG. 1B is a graph representation of the pairwise alignment of FIG. 1A.

FIG. 2A depicts exemplary alignment errors in pairwise alignment of events along two fragments of a biopolymer in accordance with the disclosed subject matter.

FIG. 2B depicts other exemplary alignment errors in pairwise alignment of events along two fragments of a biopolymer.

FIG. 3A depicts multiple alignment of events along multiple overlapping fragments of a biopolymer in accordance with the disclosed subject matter.

FIG. 3B is a graph representation of the multiple alignment of FIG. 3A.

FIG. 4A depicts multiple map alignment with alignment errors in accordance with the disclosed subject matter.

FIG. 4B is a graph representation of the multiple map alignment of FIG. 4A.

FIG. 5 illustrates an exemplary contradictory set of pairwise alignments in accordance with the disclosed subject matter.

FIG. 6 illustrates an exemplary set of fragments on which pairwise alignments will be in contradiction in accordance with the disclosed subject matter.

FIG. 7 illustrates one iteration of a method for finding a contradiction in accordance with an exemplary embodiment of the disclosed subject matter.

FIG. 8 is a flow diagram of a method for map assembly and sequence reconstruction in accordance with an exemplary embodiment of the disclosed subject matter.

### DETAILED DESCRIPTION

The terms used in this specification generally have their ordinary meanings in the art, within the context of this invention and in the specific context where each term is used. Certain terms are discussed below, or elsewhere in the specification, to provide additional guidance to the practitioner in describing the compositions and methods of the invention and how to make and use them.

As used herein, the use of the word “a” or “an” when used in conjunction with the term “comprising” in the claims and/or the specification may mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms.

The term “about” or “approximately” refer to a value one of ordinary skill in the art would consider equivalent to the recited value (i.e., having the same function or result), which will depend in part on how the value is measured or determined, i.e., the limitations of the measurement system.

The techniques disclosed herein can provide genetic map assembly using multiple alignment consensus. As used herein, the term “genetic map” or “map” means a set of ordered distances (“intervals”) between events on a biopolymer, the biopolymer including but not limited to DNA, RNA, and proteins. While certain aspects of the disclosed subject matter are described with in connection with DNA, one skilled in the art would recognize that the disclosed subject matter is not limited to these illustrative embodiments, and that the techniques disclosed herein can be applied to any suitable biopolymer.

As used herein, the term “event” includes, for example, probe binding sites. In certain exemplary embodiments, each event can have an identity (e.g., a “tag”). That is, for example, a probe may have a “tag” attached to it to make it more readily detectible. As used herein, a “tag” means a moiety that is attached to a probe in order to make the probe more visible to a detector. These tags may be proteins, double-stranded DNA, single-stranded DNA, dendrimers, particles, or other molecules or molecular complexes. Moreover, in certain embodiments, multiple different tags can be used for corresponding different probes to differentiate between probes at each probe site.

In accordance with the disclosed subject matter herein, multiple alignment consensus can provide accurate and complete consensus maps from individual fragment measurements. As used herein, the term “fragment” refers to a portion of a biomolecule unless otherwise indicated by context. When a fragment is measured (e.g., the position of events and/or the associated tags within the fragment are determined), the resulting measurement can be referred to as a “fragment map.” Each fragment map can, however, include sizing errors, missing, and/or erroneous position or tag measurements. As used herein, for purpose of simplicity, the term “fragment” can be used interchangeably with “fragment map.” One of ordinary skill in the art will appreciate that when used in this manner, the term “fragment” refers to fragment measurements rather than the physical portion of the biomolecule.

Generally, a pair of fragment maps can share homology for a number of reasons. For example, a pair of fragment maps could be approximate measurements of the same biopolymer, two biopolymers that are identical copies of a source molecule, or two biopolymers that are copies (identical or approximate) of overlapping regions of a source molecule. As used herein, a situation in which two or more fragment maps that share homology is referred to as one in which these the measurements (fragments) “overlap.”

Multiple alignment can be performed on a set of at least partially overlapping fragment maps to match events that reflect the target feature occurrences on the source biomolecule. For example, a multiple alignment can be an ordered set of sets of probe sites. Each set of aligned events can be referred to as an “aligned point.” In this manner, a consensus map can be generated by averaging the sizes of intervals (i.e., the distance between events) between aligned sets of events, thereby reducing errors in interval sizing. In like manner, tag calls (i.e., determination of the identity of a probe site) can be made with confidence by taking a probability weighted consensus of all aligned tag call information.

Further, missing and erroneous event measurements can be corrected in the consensus map. Pairwise alignment between each of a set of fragments can first be performed according to known techniques. Algorithms for pairwise sequence alignment are well characterized and widely known. Examples of such algorithms for pairwise sequence alignment include those pioneered by Needleman, Wunsch, Smith, and Waterman. See Needleman et al., Journal of Molecular Biology (1970), 48(3), 443-453; Smith et al., Journal of Molecular Biology (1981), 147(1), 195-197; Durbin et al., Biological sequence analysis: Probabilistic models of proteins and nucleic acids (1998), Chapter 2. Algorithms for pairwise sequence alignment have been structurally adapted to pairwise map alignment, for example as disclosed in Waterman et al., Computer Applications in the Biosciences (1992), 8(5), 511-520; Valouev et al., Journal of Computational Biology (2006), 13(2), 442-462; and Waterman et al., Nucleic Acids Research (1984), 12, 237-242. Such algorithms have also been utilized in conjunction with optical mapping systems. See Nagarajan et al., Bioinformatics (2008), 24(10), 1229-1235; Anantharaman et al., Journal of Computational Biology (1997), 4(2), 91-118; Anantharaman et al., ISMB (1999), 18-27; Anantharaman et al., Pacific Symposium on Biocomputing (2005).

Once all pairwise alignments are performed on a set of fragments, each fragment map can be assigned an index, and each event within each map can also be indexed. In the parlance of graph theory, each event can be represented by a vertex, identified by its indices; and each alignment can be represented by an edge (i.e., an undirected set of vertices). The multiple alignment can then be represented by the union of all pairwise alignments, represented by a graph consisting of a set of vertices corresponding to the events and a set of edges corresponding to alignment between the events. Incorrect alignments between events due to error are also represented by edges. These incorrect edges can be identified and removed, thus correcting the multiple alignment. Identification of these extra edges can include randomly selecting an edge, removing the edge and combining its vertices while retaining all other edges if the vertices of the selected edge correspond to different fragment maps. This can be repeated until only two vertices remain or no further edges can be removed. The remaining set of edges is the minimum cut (often referred to as the min-cut), and corresponds to the extra edges to be removed to generate a set of ordered pairs representing a multiple alignment consensus best reflecting all pairwise alignments. The techniques disclosed herein can include a modification of the techniques for finding a min-cut disclosed, for example, in Karger, STOC (1996), 56-63; Karger et al., J. ACM (1996), 43(4), 601-640. Such techniques can be modified, as disclosed herein, to include constraints which change the structure and derived solutions. Additionally, one of ordinary skill in the art would appreciate that previous techniques for multiple alignment using a minimum cut approach, such as that disclosed in Corel et al., lack the techniques and constraints disclosed herein. See Corel et al., Bioinformatics (2010), 26(8), 1015-1021. Furthermore, certain known approaches are generally suited for sequence multiple alignment, rather than multiple map alignment.

Further, in accordance with the subject matter disclosed herein, de novo genetic map assembly can include “on the fly” (i.e., dynamic) multiple alignment consensus construction. In connection with large length-scale biomolecules and a large number of fragments, genetic map assembly can include searching for fragments to be added to a growing consensus map. To reduce the time required to search for fragments to be added to the consensus map, a “signature” can be defined to facilitate the search process. As used herein, a “signature” refers to an ordered sequence of intervals lengths between a number of events. Discretization boundaries can be selected such that a substantially equal number of intervals over the entire data set fall in each, and thus the distribution of number of ordered discretized intervals can be uniform.

On the fly multiple alignment consensus construction can include defining a subset of fragments at least partially overlapping a putative consensus. As used herein, this subset can be referred to as a “bundle.” If the bundle is of sufficient size, multiple alignment can be performed, as disclosed herein, on the bundle to determine consensus events and corresponding locations, which can be added to a growing consensus map. When a fragment in the bundle no longer has any “forward overhang” (i.e., the events on the fragment map are all accounted for within the consensus), it can be discarded from the bundle. If the bundle size is less than a predetermined threshold, additional fragments can be searched according to a selected signature, as disclosed herein. Each fragment with the selected signature can be aligned to each fragment within the growing consensus. If an alignment score representing the alignment of each fragment with the selected signature to each fragment within the growing consensus passes one or more statistical significance tests, the fragment can be aligned to each fragment in the bundle. This process can continue until there are no remaining fragments to fill the bundle that passes the significance tests. In this manner, a consensus map can be created for each contig in a genome. As used herein, the term “contig” means a sequence of contiguous interval lengths, defined between the binding site selected by a particular reaction, composed as a consensus of at least some completed measurements.

Reference will be made in detail to the various exemplary embodiments of the disclosed subject matter, certain of which are illustrated in the accompanying drawings. The system and corresponding method of the disclosed subject matter will be described in conjunction with the detailed description of the system. The accompanying figures, where like reference numerals refer to identical or functionally similar elements, serve to further illustrate various embodiments and to explain various principles and advantages all in accordance with the disclosed subject matter. For purpose of explanation, and not limitation, exemplary embodiments of the disclosed subject matter will be described below with reference to FIGS. 1-8.

In accordance with an exemplary embodiment of the disclosed subject matter, a positional sequencing technique can be used for chromosome or genome scale mapping. For example, DNA bound with sequence-specific probe molecules can be fragmented and translocated through a nanopore from which the blockade of electrical current can be used to detect the DNA and its probes. The duration of the current change can be used to determine the position of the probes on the biomolecule fragments to generate fragment maps. Additionally or alternatively, positional sequencing techniques in accordance with the disclosed subject matter can include the use of a nano-channel, and/or techniques disclosed in commonly assigned U.S. Pat. No. 8,246,799 and U.S. Pat. No. 8,262,879, as well as U.S. Patent Publication No. 2010/0243449 and U.S. Patent Publication No. 2010/0096268, each of which is hereby incorporated by reference in its entirety. Positional sequencing measurements, however, can include measurement errors resulting from, e.g., the random thermodynamic process of annealing probes to target sequences, variable molecular configuration (including velocity and Brownian motion) during molecular sensing, and variation in electronic signal.

### Map Alignment

In the case of approximate measurements with error, the error process can be modeled as a source of random noise described by probability distributions. These sources of noise can result in uncertainty in interval sizing (positional error), missing probe sites (referred to herein as “false negatives”), erroneous probe site detections (referred to herein as “false positives”), and uncertainty in probe site identity (referred to herein as “tag call probabilities”).

Pairs of fragments can be compared (e.g., aligned) to determine if they share a homologous overlapping region and, if so, how they overlap. For purpose of illustration and not limitation, conventional pairwise alignment will be described with reference to FIG. 1A and FIG. 1B. Generally, an ordered set of matched pairs of events (e.g., probe binding sites) between the two input maps can be determined such that a score function on the level of error admitted by the alignment is optimized (e.g., maximized or minimized depending on scoring metric over all possible alignments). As illustrated in FIG. 1A, for purposes of example and not limitation, horizontal lines 110 and 120 represent overlapping DNA fragments and the tick marks (Nos. 0-6) represent events. The distance between each tick mark on lines 110 and 120 correspond to the distance between probes on the DNA fragments. Further, dotted lines (e.g., 111a and 111b) represent the alignment between probes. The ordered set of pairs of probes aligned in the optimal alignment are the pairwise alignment between two fragments. For notation, events on fragments 110 and 120 can be denoted vⱼⁱ as the j^{th} event on fragment map i. Thus, the ordered set of pairs for the alignment depicted in FIG. 1A can be given as:

{{v₂⁰, v₀¹}, {v₃⁰, v₁¹}, {v₄⁰, v₂¹}, {v₅⁰, v₃¹}, {v₆⁰, v₄¹}}.

If the score of such an alignment meets certain statistical tests the maps can be considered homologous. For example, in the case of shotgun assembly, when an alignment score passes these tests the two fragments most likely arose from copies of overlapping regions of the source molecule. Also, the aligned pairs of events in such an alignment are likely to represent measurements of the same particular locus in the genome. As illustrated in FIG. 1B, the pairwise alignment can be diagramed as a graph where the events are vertices (e.g., 130a and 130b) and an edge (e.g., 131) represents the fact that those two events have been aligned.

As noted above, while representing the optimal scoring alignment, a pairwise alignment can have errors. Generally speaking, two kinds of errors in a pairwise alignment can be defined: missing edges and extra edges. That is, events that should have been aligned as they represent measurements of the same location in the genome but were not aligned can correspond to missing edges, and two events that should not have been aligned because they represent two different locations in the genome but were aligned can be referred to as extra edges. Extra edges can occur either because the fragments themselves arose from different locations in the genome or when a local error of aligning two events that because of positional error or false positives and false negatives appeared to be the same event under the tolerated error. FIG. 2A and FIG. 2B illustrate exemplary causes of alignment errors. For example, with reference to FIG. 2A, a false positive measurement 210 can create alignment errors. Similarly, and with reference to FIG. 2B, false negative 220 can also create alignment errors. In certain embodiments, the error in the data can be modeled and incorporated in a scoring system that minimizes these alignment errors.

For purposes of illustration and not limitation, multiple alignment will be described with reference to FIG. 3A and FIG. 3B. Generally, multiple alignment can match input map events in sets (e.g., 310a, 310b, and 310c (collectively 310)) that reflect the target feature occurrences on the source molecule from which the inputs originated. In structure, a multiple alignment is an ordered set of sets of probe sites 310. Each set (i.e., aligned point) can consist of at most one probe landing on each measurement map. Additionally, each probe landing on each measurement map can be present in at most one set. Finally, the sets can obey the ordering principle: if events a, b, and c occur on the same input map such that b lies after a and before c, and each of a, b, and c is in an aligned point, the aligned point containing b lies after the aligned point which contains a and before that which contains c in the multiple alignment. Intuitively, each aligned point consists of those events that “match,” i.e., that are measurements of the same locus in the genome.

In connection with positional sequencing and in accordance with an exemplary embodiment of the disclosed subject matter, multiple alignment can be useful for creating a more accurate and complete consensus map than is represented by individual fragment measurements, as fragments can suffer from sizing errors, missing and erroneous probe measurements, and uncertain tag calls. Error in interval sizing can be corrected by averaging the sizes of intervals between aligned sets of probes. Missing and erroneous probe site errors can be corrected by requiring confirmatory probe site measurements shared within sets in the multiple alignment. That is, for example, the techniques disclosed herein can group probes as being independent measurements of the same locus in the genome. Independent measurements can then be averaged and/or majority-voted to reduce error in the consensus. Tag calls can be made with higher confidence by taking the probability weighted consensus of all aligned tag call information. In this manner, a multiple alignment can be more useful than a pairwise alignment. That is, the ability to average more than two intervals can further decrease positional error. In a pairwise alignment, when there is an event that is not aligned to an event in the other map, it can be unclear whether (i) that event is a false positive, (ii) there is a false negative in the other map at that approximate location, or (iii) if the probe it corresponds to has been perturbed by distance error further than that which would have made the two align in the optimal alignment. Additionally, pairwise alignment errors sensitive to measurement errors can be corrected by the multiple alignment, thereby improving the efficacy of the previous two statements even further.

As with pairwise alignment, multiple alignment can be represented by a graph as illustrated in FIG. 3B. In the parlance of graph theory, the aligned points that make up a multiple alignment can be equivalence classes, such that every pair of events in such a set has the relation “are homologous.” A graph can be built representing these pairwise relations, where a vertex vₗᵢ represents the j^{th} event on map i and the undirected edge (vⱼⁱ, vₗ^{k}) represents that vⱼⁱ and vᵢ^{k} are homologous with respect to the map of common origin. By way of notation, vₗ^{k}·m=i and vₗ^{k}·e=j. Because, by definition, those events in a given aligned point are homologous to one another and to no other events, each connected component (e.g., 320a, 320b, and 320c (collectively 320)) in this graph can be fully connected and consists of the events in one aligned point. That is, for perfect pairwise alignment between all fragments, a series of clique subgraphs 320 can result.

For purposes of illustration and not limitation, the multiple alignment graph can be denoted graph G, consisting of a set of vertices V and a set of edges E. For each pair j and l, Eⱼₗ=Eₗⱼ=(u,v) can be defined in E such that u.m=j and v.m=l. Since each pair of events (u,v) in E can come from exactly one pair of different maps, the set of all Eⱼₗ is a portioning of E. Eⱼₗ can define a pairwise alignment between maps j and l, consisting of the pairs of homologous events between these two maps. That Eⱼₗ is a partitioning of E is also to say that E is the union over all such pairwise alignments. Accordingly, determination of perfect multiple alignment between a collection of maps can be accomplished by taking the union of perfect pairwise alignments.

As noted above, as a result of measurement noise a given pairwise alignment may not be perfect. As used herein, “perfect alignment” refers to an ordered set of aligned points consisting of one matched pair for each event in the intersection of true positives in the two maps. For example, for two maps, x and y, with events x₁ . . . m and y₁ . . . n, each event can derive either from a genomic site γ or from a false positive. In the latter case, the event is not homologous to an event on any other map and a perfect pairwise alignment will not include this event in a matched pair. In the former case, this event will be matched if and only if the other map has an event deriving from γ. For purposes of illustration, and with reference to FIG. 4A, multiple map alignment with several maps having false negatives (410a, 410b, and 410c (collectively 410)) is depicted. The desired sets of pairwise alignments (e.g., 420a, 420b, and 420c) are identified notwithstanding the imperfect pairwise alignments resulting from the false negatives.

In accordance with an exemplary embodiment of the disclosed subject matter, missing and erroneous event measurements can be corrected in connection with multiple alignment. Incorrect alignments between events arising from missing or erroneous event measurements can be represented by extra edges. These extra edges can be identified and removed, thus correcting the missing or erroneous event measurements. Identification of these extra edges can include randomly selecting an edge, removing the edge and combining its vertices while retaining all other edges if the vertices of the selected edge correspond to different fragment maps. This can be repeated until only two vertices remain or no further edges can be removed. For example, this process can be repeated numerous times and the graph with the fewest remaining edges can be chosen. The remaining set of edges is the min-cut, and corresponds to the extra edges to be removed to generate a set of ordered pairs representing a multiple alignment consensus best reflecting all pairwise alignments as described above.

For purposes of illustration and not limitation, description will be made to illustrative techniques for correcting missing and erroneous event measurements. Pairwise alignment can be performed between all pairs of a set of input maps. The set of edges E′ (and the graph G′=V, E′) can be formed by taking the union of these imperfect pairwise alignments. E′ differs from the perfect solution E in its missing and extra edges. The extra edges mean that E′ has edges between what would be separated components in E. Additionally, some edges are missing within what would be connected components of E. However, these missing edges can be less of a concern under the assumed coverage because it can be unlikely that enough edges might be missing to separate a component into two or more components. In order to recover E as best possible, the extra edges can be removed from E′.

As disclosed herein, the extra edges in E′ can introduce “contradictions.” As used herein, the term “contradiction” refers to a connected component in a graph G′ that contains two or more different vertices from the same map. That is, the multiple alignment implicit from can count two events on one measurement map arising from a single event in the underlying true map. This is always an error because each aligned point in the multiple alignment should correspond to a particular event γ in the map of common origin and it is impossible for two sites on the same map to be homologous to the same γ. For purpose of illustration and not limitation, FIG. 5 depicts an example of a contradictory set of pairwise components. As depicted therein, v₀⁰ is aligned to v₀¹, which is aligned to v₀² but in the alignment between maps 0 and 2, v₁⁰ is aligned to v₀². These are inconsistent assignments of homology and therefore a contradiction. Accordingly, these contradictory components can be separated into non-contradictory components.

Assuming most edges in E′ are correct, these contradictions can be fixed by finding a min-cut such that no contradictions remains. Generally, the min-cut of a graph can be identified by finding strongly connected components and severing them from one another. These strongly connected components can be identified by “contracting” edges until a certain condition is met (e.g., until only two nodes remain). As used herein, “contracting” an edge refers to removing the edge and combining its end nodes into one node retaining all other edges therefore allowing multiple edges between two nodes. The selected cut itself is the set of all edges remaining when no further contraction is allowed. For purpose of illustration and not limitation, FIG. 4B depicts an example graph representation of alignments of the maps contained in FIG. 4A. This alignment graph includes contradictions arising from the false negatives 410. Lines 430a and 430b illustrate the edges that must be cut in order to obtain a contradiction-free multiple alignment that best explains all of the pairwise alignments.

In accordance with an exemplary embodiment of the disclosed subject matter, a constraint can be imposed such that no two vertices representing events on the same map can be contracted. To wit, fully-contracted vertices after no further contractions are allowed can be identical to the aligned points of the multiple alignment. Accordingly, edges can be contracted at random without violating the constraint until no contractions are allowed under the constraints or only two nodes remain. This process can be repeated numerous times selecting the solution with the fewest remaining edges, therefore the smallest cut, improving the probability of finding the “min cut”. The resulting min-cut can represent a likely selection of the extra edges in E′ and can result in an ordered set of non-contradictory connected components that best explain the set of pairwise alignments.

For purpose of illustration and not limitation, the technique of edge removal to identify extra edges will be described in connection with an example set of fragments and with reference to FIG. 6 and FIG. 7. FIG. 6 depicts a set of fragments, each with a set of events therein. As depicted therein, the pairwise alignments for these fragments is in contradiction due to event 2 on fragment v⁴. For purposes of this illustrative description, the set of fragments is assumed to overlap a common portion of a source biomolecule. However, as illustrated in the figure, fragment measurements include positional error and a false negative. With reference to FIG. 7, edge {v₅⁰, v₃³} is first selected and contracted. That is, edges are drawn at random and contracted if they do not have labels of the same fragment (i.e., the index of the fragment map, depicted in FIG. 7 as superscript). This process can continue until either there are 2 nodes left in the graph and the remaining edges are the “cut,” or no more edges can be contracted under the constraint that vertices representing events on the same map cannot be contracted. At this point, the cut with the fewest cut edges is selected as the most likely.

### Multiple Alignment Consensus Construction

In accordance with another exemplary embodiment of the disclosed subject matter, de novo genetic map assembly can include “on the fly” multiple alignment consensus construction. For purpose of illustration and not limitation, description will be made generally of genetic map assembly. While certain approaches to genetic map assembly are known, due to time complexity these techniques can fail to easily extend to large mammalian genomes. For example, mapping of large genomes can require the use of a reference genome. Alternatively, iterative divide and conquer methods using powerful computers (e.g., a cluster of servers) can be used. For example, such methods can include those described in Anantharaman et al., ISMB (1999), 18-27; Anantharaman et al., Pacific Symposium on Biocomputing (2005); Valouev et al., Proceedings of the National Academy of Sciences (2006), 103(10), 15770-15775; Valouev et al., Bioinformatics (2006), 22(10), 1217-1224; Zhou et al., PLoS Genet (2009), 5(11), e1000711. However, such approaches can suffer from various drawbacks, including cost and expense concerns.

The difficulty associated with genetic map assembly can result from inherently higher complexity of pairwise and multiple alignment relative to their analogous sequencing counterparts. That is, pairwise alignment can have O(n²) complexity for sequence alignment where n is the number of bases. By contrast, map alignment can have complexity O(n⁴) where n is the number of events. Furthermore, because sequencing error rates are initially an averaging over many molecules, the resulting reads can have relative little error. Thus, in connection with sequencing, exact matches of certain lengths of sequences can be identified. Hashing reads by these exact values can allow for constant time lookups, thereby obviating the problem of alignment, for example as disclosed in Miller et al., Genomics (2010), 95(6), 315-327; Myers et al., ECCB/JBI (2005), 85. However, such techniques are not possible with mapping as each “read” is a single molecule measurement which can be inherently noise prone.

The size of a genetic map assembly problem can be based on the size of the genome as well as the frequency with which the specific target appears in that genome. Because this frequency can vary significantly, the number of events can be a better proxy for the size of the problem than genome length. In a random genetic sequence of sufficient length all sequences of a particular length K can occur with equal probability. In a random sequence, a given K-mer can occur as a Poisson process with frequency

$$λ = \frac{1}{{4}^{K}}$$

and the intervals between these occurrences can follow a geometric distribution with μ=4^{K}. In non-random DNA such as real genomes, the frequency of a given K-mer can be significantly different from the random model but still closely follow a Poisson distribution with that particular frequency. The size of the genetic map assembly problem can grow at least linearly with the sequence specific target frequency. For example, in connection with certain optical mapping technologies, target sequences can occur at a frequency of once every 10,000 bases

$$( λ = \frac{1}{10 \text{,} 000} )$$

or more. With an increase in sequence frequency (e.g., to obtain “higher resolution”), comes an increase in the complexity of the problem. Additionally, error level including positional, false negatives, and positives can also increase complexity in poorly defined ways, as certain approximation optimizations in searching for fragments as well as in pairwise alignment can be sensitive to these errors.

In an exemplary embodiment of the disclosed subject matter, positional sequences can be used to target sequences that occur approximately once every 2,000 to 6,000 bases

$$( λ = \frac{1}{2 \text{,} 000} to \frac{1}{6 \text{,} 000} ) .$$

The techniques disclosed herein can provide for genetic map assembly that can assemble a mammalian sized genome with event frequency of one in every 2,000 at 30 fold coverage in approximately one hour on standard commercially available processors (e.g., a single core of a commodity sandy bridge i7 processor with less than or equal to 8 Gb of ram).

In connection with this exemplary embodiment, and for purposes of illustration and not limitation, the assembly process can be sped up by efficiently searching for fragments that contain a short segment that is similar to a part of the growing consensus map. A signature can be defined as an ordered sequence of discretized interval lengths between S events. These signatures can be reliable (i.e., they can be discretized to the same value as they would with no error). Additionally, searching for these signatures can be accomplished with constant time look up. That is, intervals can be averaged to certain chosen discrete values. The discretization of these intervals can be designed to efficiently hash fragments into collections of roughly equal size. To do so, the approximation can be made that if boundaries to predetermined discrete values are chosen such that an equal number of intervals over the entire data set fall in each then the distribution of number of ordered discretized intervals will also be uniform.

The signature can be defined by interval lengths as measured by the number of base pairs between events. For example, a number of “bins” can be defined, with each bin corresponding to a range of base pairs. For purpose of illustration, and not limitation, Table 1 includes three exemplary sequences of ranges of base pairs, each corresponding to a “bin.” One of ordinary skill in the art will appreciate that the number of bins, as well as the range of base pairs within each bin, are not limited to the examples disclosed herein. For example, different levels of granularity can be achieved by using granularity functions known to those skilled in the art to determine suitable boundaries for the base pair ranges for each bin. Table 1 provides three examples of granularity function boundaries with 5, 8, and 10 bins, respectively. Moreover, in accordance with an exemplary embodiment of the disclosed subject matter, bins corresponding to higher interval sizes can be wider (i.e., can have a larger range of base pairs). This can compensate for anticipated scarcity of these longer intervals as well as larger uncertainty in sizing longer intervals.

TABLE 1

| | Number of base | Number of base | Number of base |
|---|---|---|---|
| | pairs | pairs | pairs |
| Bin Number | (5 Bins) | (8 bins) | (10 bins) |
| 1 | 0-401 | 0-533 | 0-113 |
| 2 | 402-1608 | 534-1150 | 114-454 |
| 3 | 1609-3620 | 1151-1879 | 455-1022 |
| 4 | 3621-6437 | 1880-2772 | 1023-1818 |
| 5 | 6438+ | 2773-3922 | 1819-2842 |
| 6 | | 3923-5544 | 2843-4092 |
| 7 | | 5545-8317 | 4093-5571 |
| 8 | | 8318+ | 5572-7276 |
| 9 | | | 7277-9209 |
| 10 | | | 9210+ |

A particular fragment's signature can correspond to a sequence of bins, as defined by the number of base pairs between events S on the fragment. That is, for purpose of example and not limitation, a fragment with 5 events {S₁, . . . , S₅} (e.g., probe sites) can have a signature of a sequence of four bin numbers corresponding to the number of base pairs between each of the five events. With reference to the 5-bin example of Table 1, a fragment with 200 base pairs between S₁ and S₂, 1700 base pairs between S₂ and S₃, 150 base pairs between S₃ and S₄, and 872 base pairs between S₄ and S₅, the fragment can have a signature of {1, 3, 1, 2}. Alternatively, with reference to the 10-bin example of Table 1, the same fragment can have a signature of {2, 4, 2, 3}.

A putative consensus map can be generated as disclosed herein going at S events where S is a parameter in a predetermined range (e.g., 4 to 6). Assuming there is a collection of fragments that overlap the putative consensus, this collection of fragments can be referred to as the “bundle.” This exemplary technique can be seeded with a random fragment. At each step in this exemplary technique, one of two events occurs, as outlined below.

First, if the bundle size is less than a predetermined threshold, e.g., some number B (which can be, for example, 6 to 12), search for fragments to add to the bundle until it is of size B. As disclosed herein, the size of the bundle can be a fixed number determined by data analysis or a fixed fraction of coverage as determined by data analysis. When searching for fragments to add to the bundle, a signature can be selected and an attempt to align each fragment with that signature to the growing consensus can be made. For example, with reference to Table 1, if the current consensus map includes aligned fragments having signatures starting with {1, 4, 4, 3}, a candidate fragment to be added to the bundle can be identified by selecting a fragment starting with the same signature. In accordance with an exemplary embodiment, the consensus can have signatures that are more accurate than those of the individual fragments from which it was generated.

If an alignment score passes a statistical significance test then the new fragment can be aligned to each of the B fragments that currently overlap the growing consensus and generating multiple alignment scores. If each of these alignment scores passes significance tests that fragment can be added to the bundle. In one embodiment, for example, the score of the pairwise alignment can be a log-likelihood ratio from which Bayesian statistic may be used to generate a probability of matching. See Valouev et al., Journal of Computational Biology (2006), 13(2), 442-462.

Second, if the bundle is of sufficient size, a multiple alignment can be performed on these fragments as previously described to pick consensus events and their locations and add them to the growing consensus.

When a fragment in the bundle no longer has any forward overhang it can be discarded from the bundle. This process can continue until it is not possible to find enough fragments to fill the bundle that pass these significance tests. This process can be run in both directions for each contig. When one contig ends a new contig can be started in the same manner as before until no further progress can be made.

In accordance with another exemplary embodiment of the disclosed subject matter, and with reference to FIG. 8, a single map may have sites corresponding to multiple different sequences (e.g., using a plurality of probes). This heterogeneity can result from using a mixture of probe molecules, using a single probe molecule that targets multiple sequences, a combination of these two, or other approaches. In the case where a single map is produced using a mixture of probe molecules, these probes can have a sufficiently different chemical makeup so as to produce differentiable signal traces from a positional sequencing instrument. In this case, the genetic map can consist of a set of ordered distances (intervals) between probe binding events (probe sites) as well as an annotation as to the probable identity of identities of each probe site (tags).

For example, in one embodiment, the full sequences of a chromosome or genome can be mapped. Raw data 810 can be received from a positional sequencing device, for example using the techniques disclosed in previously incorporated U.S. Pat. Nos. 8,246,799 and 8,262879, and U.S. Patent Publication Nos. 2010/0243449 and 2010/0096268. Signal analysis 820 can be performed to convert the signal measurements in the time domain into maps of distance between probe landings. That is, each fragment 821 can be mapped. A plurality of fragments 822 can be overlapping fragments, as disclosed herein. For each probe, a map can be assembled 830. That is, for example, the techniques disclosed herein can be applied to fragments including a first probe type to generate a probe-specific genetic map 831. A plurality of these fragment specific maps 832 can be generated for different probes. From the positional maps of a collection of probes, a chromosome's complete DNA sequence 840 can be reconstructed by iteratively extending a growing DNA sequences, as disclosed herein, and the highest probability sequence can be recovered.

The techniques disclosed herein can be embodied in, for example, a computer program. The computer program can be stored on a computer readable medium, such as a CD-ROM, DVD, Magnetic disk, ROM, RAM, or the like. The instructions of the program can be read into a memory of one or more processors included in one or more computing devices, such as for example a computer, server, cluster of servers, or distributed computing system. When executed, the program can instruct the processor to control various components of the computing device. While execution of sequences of instructions in the program causes the processor to perform certain functions described herein, hard-wired circuitry may be used in place of, or in combination with, software instructions for implementation of the presently disclosed subject matter. Thus, embodiments of the present invention are not limited to any specific combination of hardware and software.

As described above in connection with certain embodiments, a computer including one or more processors can be provided to perform pairwise alignment, multiple alignment, and other functions associated with genetic map assembly, and can generate consensus maps used by the techniques disclosed herein to provide on the fly distance map assembly. In certain embodiments, the computer and or processors can be coupled to the device for generating signal fragments so as to receive the raw signal and construct distance maps. In these embodiments, the computer plays a significant role in permitting the techniques disclosed herein to provide genetic map assembly capable of assembling a mammalian sized genome with event frequency of one in 2,000 at 30 fold coverage in approximately one hour. For example, the presence of the computer and other hardware provides the ability to map large length-scale genomes de novo in a high throughput manner.

While the disclosed subject matter is described herein in terms of certain exemplary embodiments, those skilled in the art would recognize that various modifications and improvements can be made to the disclosed subject matter without departing from the scope thereof. Moreover, although individual features of one embodiment of the disclosed subject matter can be discussed herein or shown in the drawings of the one embodiment and not in other embodiments, it should be apparent that individual features of one embodiment can be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A method for de novo genetic map assembly of a biomolecule, comprising:
(a) creating a plurality of biomolecule fragments from the biomolecule, each fragment having one or more probes bound thereto at corresponding sequence specific binding sites;
(b) generating a plurality of fragment maps corresponding to the plurality of biomolecule fragments by position sequencing the one or more probes, each fragment map including events and locations corresponding to the one or more probes;
(c) performing a multiple map alignment on a defined bundle to determine consensus events and corresponding locations, wherein the defined bundle includes a subset of the plurality of fragment maps;
(d) removing one of the number of fragment maps from the bundle when there is no overhang from the consensus events; and when the subset of fragment maps in the bundle is less than a predetermined threshold:
(i) aligning one or more of remaining fragment maps of the plurality of fragment maps, the remaining fragment maps having a signature, with the consensus events to generate a consensus alignment score; and
(ii) aligning the one or more remaining fragment maps to each of the fragment maps in the bundle to generate a corresponding pairwise alignment score, wherein if the consensus alignment score and the pairwise alignment scores exceed a significance threshold the one or more remaining fragment maps are added to the bundle.

2. The method of claim 1, wherein the biomolecule includes a biomolecule selected from the group consisting of DNA, RNA, or proteins.

3. The method of claim 1, wherein the predetermined threshold is a fixed number determined by data analysis or a fixed fraction of coverage as determined by data analysis.

4. The method of claim 1, wherein the predetermined threshold is between 6 and 12 fragments.

5. The method of claim 1, wherein aligning one or more of the remaining fragment maps further comprises selecting the one or more of the remaining fragment maps using the corresponding signature, and wherein the signature corresponds to a sequence of bins, as defined by the number of base pairs between events, on the fragment maps.

6. The method of claim 1, wherein the consensus alignment score is generated by performing multiple alignment of the plurality of fragment maps, and wherein performing multiple alignment on the plurality of fragment maps further comprises:
(a) performing pairwise alignments between each of the plurality of fragment maps to generate a graph having a plurality of edges and vertices representing each pairwise relation, wherein each vertex of the graph corresponds to an event on one of the maps, and wherein each edge of the graph corresponds to predicted homologous events;
(b) generating at least a first ordered set of sets of events representing a multiple alignment reflecting all pairwise alignments by:
(i) randomly selecting an edge; and
(ii) removing the selected edge and combining its vertices while retaining all other edges if the vertices of the selected edge correspond to different fragment maps;
(iii) repeating the steps of randomly selecting and removing until either only two vertices remain or no further edges can be removed;

7. The method of claim 6, further comprising, for the graph:
(a) generating a plurality of ordered sets of sets of events representing a multiple alignment reflecting all pairwise alignments; and
(b) selecting one of the resulting plurality of ordered sets having the fewest remaining edges, thereby identifying an ordered set of sets of events representing a multiple alignment best reflecting all pairwise alignments with high probability.

8. A method for de novo genetic map assembly of a biomolecule with a plurality of fragment maps corresponding thereto, comprising:
(a) receiving, at a processor, data representing the plurality of fragment maps;
(b) performing, with the processor, a multiple map alignment on a defined bundle to determine consensus events and corresponding locations, wherein the defined bundle includes a subset of the plurality of fragment maps;
(c) monitoring, with the processor, an overhang state of each fragment map in the bundle relative to the consensus events and a bundle size state representing the number of fragments in the defined bundle, whereby a fragment map is removed from the bundle when the corresponding overhang state reaches a predetermined criteria, and when the bundle size state is below a predetermined threshold:
(d) aligning, with the processor, one or more of remaining fragment maps of the plurality of fragment maps, the remaining fragment maps having a signature, with the consensus events to generate a consensus alignment score; and
(e) aligning, with the processor, the one or more remaining fragment maps to each of the fragment maps in the bundle to generate a corresponding pairwise alignment score; and
(f) adding the one or more remaining fragment maps to the bundle if the consensus alignment score and the pairwise alignment scores exceed a significance threshold.

9. The method of claim 8, wherein the biomolecule includes a biomolecule selected from the group consisting of DNA, RNA, or proteins.

10. The method of claim 8, wherein the predetermined threshold is a fixed number determined by data analysis or a fixed fraction of coverage as determined by data analysis.

11. The method of claim 8, wherein the predetermined threshold is between 6 and 12 fragments.

12. The method of claim 8, wherein aligning, with the processor, one or more of the remaining fragment maps further comprises selecting, with the processor, the one or more of the remaining fragment maps using the corresponding signature, and wherein the signature corresponds to a sequence of bins, as defined by the number of base pairs between events, on the fragment maps.

13. The method of claim 8, wherein the consensus alignment score is generated by performing, with the processor, multiple alignment of the plurality of fragment maps, and wherein performing multiple alignment on the plurality of fragment maps further comprises, with the processor:
(a) performing pairwise alignments between each of the plurality of fragment maps to generate a graph having a plurality of edges and vertices representing each pairwise relation, wherein each vertex of the graph corresponds to an event on one of the maps, and wherein each edge of the graph corresponds to predicted homologous events;
(b) generating at least a first ordered set of sets of events representing a multiple alignment reflecting all pairwise alignments by:
(i) randomly selecting an edge; and
(ii) removing the selected edge and combining its vertices while retaining all other edges if the vertices of the selected edge correspond to different fragment maps;
(iii) repeating the steps of randomly selecting and removing until either only two vertices remain or no further edges can be removed;

14. The method of claim 13, further comprising, with the processor, for the graph:
(a) generating a plurality of ordered sets of sets of events representing a multiple alignment reflecting all pairwise alignments; and
(b) selecting one of the resulting plurality of ordered sets having the fewest remaining edges, thereby identifying an ordered set of sets of events representing a multiple alignment best reflecting all pairwise alignments with high probability.

15. A non-transitory computer readable medium containing computer-executable instructions that when executed cause one or more computer devices to perform a method for de novo genetic map assembly of a biomolecule with a plurality of fragment maps corresponding thereto, comprising:
(a) performing a multiple map alignment on a defined bundle to determine consensus events and corresponding locations, wherein the defined bundle includes a subset of the plurality of fragment maps;
(b) removing one of the number of fragment maps from the bundle when there is no overhang from the consensus events; and when the subset of fragment maps in the bundle is less than a predetermined threshold:
(i) aligning one or more of remaining fragment maps of the plurality of fragment maps, the remaining fragment maps having a signature, with the consensus events to generate a consensus alignment score; and
(ii) aligning the one or more remaining fragment maps to each of the fragment maps in the bundle to generate a corresponding pairwise alignment score, wherein if the consensus alignment score and the pairwise alignment scores exceed a significance threshold the one or more remaining fragment maps are added to the bundle.

16. The non-transitory computer readable medium of claim 15, wherein the biomolecule includes a biomolecule selected from the group consisting of DNA, RNA, or proteins.

17. The non-transitory computer readable medium of claim 15, wherein the predetermined threshold is a fixed number determined by data analysis or a fixed fraction of coverage as determined by data analysis.

18. The non-transitory computer readable medium of claim 15, wherein the predetermined threshold is between 6 and 12 fragments.

19. The non-transitory computer readable medium of claim 15, wherein aligning one or more of the remaining fragment maps further comprises selecting the one or more of the remaining fragment maps using the corresponding signature, and wherein the signature corresponds to a sequence of bins, as defined by the number of base pairs between events, on the fragment maps.

20. The non-transitory computer readable medium of claim 15, wherein the consensus alignment score is generated by performing multiple alignment of the plurality of fragment maps, and wherein performing multiple alignment on the plurality of fragment maps further comprises:
(a) performing pairwise alignments between each of the plurality of fragment maps to generate a graph having a plurality of edges and vertices representing each pairwise relation, wherein each vertex of the graph corresponds to an event on one of the maps, and wherein each edge of the graph corresponds to predicted homologous events;
(b) generating at least a first ordered set of sets of events representing a multiple alignment reflecting all pairwise alignments by:
(i) randomly selecting an edge; and
(ii) removing the selected edge and combining its vertices while retaining all other edges if the vertices of the selected edge correspond to different fragment maps;
(iii) repeating the steps of randomly selecting and removing until either only two vertices remain or no further edges can be removed;

21. The non-transitory computer readable medium of claim 20, further comprising, for the graph:
(a) generating a plurality of ordered sets of sets of events representing a multiple alignment reflecting all pairwise alignments; and
(b) selecting one of the resulting plurality of ordered sets having the fewest remaining edges, thereby identifying an ordered set of sets of events representing a multiple alignment best reflecting all pairwise alignments with high probability.

22. A method for performing multiple alignment of a plurality of fragment maps, comprising:
(a) performing pairwise alignments between each of the fragment maps to generate a graph having a plurality of edges and vertices representing each pairwise relation, wherein each vertex of the graph corresponds to an event on one of the maps, and wherein each edge of the graph corresponds to predicted homologous events;
(b) generating at least a first ordered set of sets of events representing a multiple alignment reflecting all pairwise alignments by:
(i) randomly selecting an edge; and
(ii) removing the selected edge and combining its vertices while retaining all other edges if the vertices of the selected edge correspond to different fragment maps;
(iii) repeating the steps of randomly selecting and removing until either only two vertices remain or no further edges can be removed;

23. The method of claim 22, further comprising, for the graph:
(a) generating a plurality of ordered sets of sets of events representing a multiple alignment reflecting all pairwise alignments; and
(b) selecting one of the resulting plurality of ordered sets having the fewest remaining edges, thereby identifying an ordered set of sets of events representing a multiple alignment best reflecting all pairwise alignments with high probability.
